(19) United States
(12) Patent Application Publication
(10) Pub. No.: US 2006/0151535 A1
(43) Pub. Date: Jul. 13, 2006

(54) Dispensing device for fluid product

(76) Inventors: Frederic Duquet, Thibouville (FR); Jean-Paul Lecoutre, Breteuil sur Iton (FR); Alex Milian, Breteuil sur Iton (FR)

Correspondence Address: SUGHRUE MION, PLLC, 2100 PENNSYLVANIA AVENUE, N.W., SUITE 800, WASHINGTON, DC, 20037, US

(21) Appl. No.: 10/521,316

(22) PCT Filed: Jul. 8, 2003
(86) PCT No.: PCT/FR03/02126

§ 371 Date: Jan. 14, 2005

(30) Foreign Application Priority Data
Jul. 16, 2002 (FR) 0208986

(51) Int. Cl. B67D 5/06; B65D 37/00; B65D 47/10

(52) U.S. Cl. 222/183; 222/206; 222/541.6

(57) ABSTRACT

A fluid dispenser assembly comprising:
a dispenser (1) comprising a fluid reservoir defining a deformable actuator wall (13), a dispenser orifice through which the fluid is dispensed by pressing on the deformable actuator wall, and a removable closure member (16) which covers the dispenser orifice at least before it is first used; and
an outer wrapper (3) which surrounds the dispenser,
the dispenser being characterized in that it further comprises a substantially rigid reinforcing structure (2) provided with reception means (225) for receiving the dispenser (1), and defining application zones (211, 212, 213, 262) where the outer wrapper is in contact with the reinforcing structure in such a manner as to surround, at least in part, both the dispenser and the reinforcing structure.

The present invention relates to a fluid dispenser assembly comprising: a dispenser comprising a fluid reservoir defining a deformable actuator wall, a dispenser orifice through which the fluid is dispensed by pressing on the deformable actuator wall, and a removable closure member which covers the dispenser orifice at least before it is first used; and an outer wrapper surrounding the dispenser. This type of dispenser assembly can find advantageous applications in the fields of perfumery, cosmetics, or even pharmacy.

Document FR 2 796 368 describes such a dispenser assembly comprising a dispenser placed in an outer wrapper. In addition, the dispenser and the outer wrapper described in that prior-art document can be used perfectly well in the present invention. Specifically, the fluid dispenser of that document is made from a shell that is advantageously thermoformed, and that is associated with a protective film. The shaped shell and the protective film together define an inside volume, serving mainly as a fluid reservoir. The reservoir can be filled completely with fluid, or can be filled only in part, with the remainder being filled with a gas, e.g. air. The dispenser includes a dispenser orifice that is masked before it is first used by a removable closure member which can be folded or torn along a predetermined rupture line. The dispenser orifice can be formed by the shell or by the protective film, but the dispenser orifice is preferably formed by a support part, generally made of plastics material, that is interposed between the shell and the protective film. The dispenser is thus in the form of a small plate defining a substantially flat and plane margin, inside which the shell forms a kind of dome enclosing the reservoir, the support part, and the end of the removable closure member. That is a particular type of embodiment usable in the context of the present invention, but that embodiment must not be considered as unique. In the present invention, it is possible to use any type of dispenser that defines at least a reservoir that can be pressed so as to deform or displace an actuator wall, thereby dispensing the fluid through a dispenser orifice that is advantageously closed before it is first used by a removable closure member.

With regard to the outer wrapper, it is constituted in document FR 2 796 368 by a simple sheet of paper, cardboard, plastics, metal, or even other suitable materials. The sheet is folded in half so as to form a kind of case inside which the dispenser is placed. The outer wrapper comprises a bottom portion designed to be positioned in contact with the protective film of the dispenser, a bulging front portion which extends over the dome formed by the shaped shell, and a flap portion which overlaps the bottom portion in order to be bonded thereto, thereby closing the case. The outer wrapper is therefore in the form of a case presenting a flat bottom and a bulging top. The outer wrapper also includes a tear-off or foldable portion which is demarcated from the remainder of the wrapper by a predetermined rupture line. The rupture line is advantageously positioned in aligned or superposed manner relative to the rupture line of the dispenser. Thus, by tearing-off or by folding-back the removable portion of the outer wrapper, the removable closure member of the dispenser is also removed, thereby unmasking the dispenser orifice. With regard to actuating the dispenser assembly, this is done very simply by exerting pressure on the bulging portion of the outer wrapper where the actuator wall of the dispenser is formed. In other words, the dispenser is actuated by pressing on the outer wrapper.

A drawback with that prior-art dispenser assembly resides in the fact that both ends of the wrapper are left open, such that the dispenser can be seen via both ends. This appearance is not very advantageous. In addition, the bulging front face of the outer wrapper has only a small amount of support, such that it tends to deform at its ends. Furthermore, when the removable closure member is removed or folded-back, the internal arrangement of the dispenser assembly becomes visible, and this too is not very attractive. Finally, again as a result of the lack of support for the bulging front portion of the outer wrapper, it is difficult for the user to hold the dispenser assembly, and the user immediately senses that the dispenser assembly is somewhat fragile.

An object of the present invention is to remedy those drawbacks associated with the prior-art dispenser assembly. To do this, the present invention proposes that the dispenser assembly further comprises a substantially rigid reinforcing structure provided with reception means for receiving the dispenser, and defining application zones where the outer wrapper is in contact with the reinforcing structure in such a manner as to surround, at least in part, both the dispenser and the reinforcing structure. The reinforcing structure makes it possible not only to improve the dispenser assembly and to impart strength thereto, but also makes it possible to protect the dispenser which is housed therein. It is thus possible to prevent any risk of the dispenser, and more particularly its reservoir, being damaged by flattening or denting. The reinforcing structure thus serves as a protective sheath for the dispenser, and as a stable and solid support element for the outer wrapper.

The reinforcing structure advantageously includes a slot, the actuator wall of the dispenser being positioned at the slot, the outer wrapper covering the slot so that the actuator wall can be actuated through the wrapper. The slot is preferably bordered by first application zones for the outer wrapper. In an embodiment, the reinforcing structure may include a body defining a front face and a rear face, the front face forming the slot and the first application zones, and the rear face being substantially open and provided with first reception means for receiving the dispenser, such that the dispenser is engageable in the body via its rear face, and is positioned in said body with its actuator wall accessible through the slot of the body. The body advantageously includes a trailing end plate.

In more detailed manner, the first application zones of the body may comprise a bottom zone, a top zone, and two lateral zones connecting the bottom zone to the top zone, thereby bordering the slot. For example, the application zones may be curved in such a manner as to form together a cylindrical segment in which the slot is pierced.

According to another aspect of the invention, the body includes a top wall at which the dispenser orifice opens out. In addition, the dispenser may include a substantially plane rear face which closes the open rear face of the body, the outer wrapper covering the rear face of the dispenser.

According to another advantageous aspect of the invention, the reinforcing structure includes a head defining a front face and a rear face, the front face forming a second application zone for the outer wrapper, and the rear face being open and provided with second reception means for receiving the removable closure member of the dispenser. The head is advantageously connected to the body by at least one bridge of foldable or breakable material, so that the head can be folded onto or detached from the body, taking with it the removable closure member, thereby uncovering the dispenser orifice.

The head advantageously includes a bottom wall through which the removable closure member passes. In addition, the head may include a leading end plate which covers and closes the head.

The second application zone is preferably curved in such a manner as to form a cylindrical segment. It is also preferable for the first application zones and the second application zone to present identical curvature.

According to another aspect, each of the trailing and leading end plates forms a respective rim which projects against the application zones. The outer wrapper can thus be held stationary on the reinforcing structure by being in blocked contact against the rims formed by the trailing and leading end plates. It is thus possible to prevent the outer wrapper from sliding on the reinforcing structure.

More generally, it is preferable for the application zones to be curved in such a manner as to form a cylindrical segment on which the outer wrapper is applied, and preferably blocked.

Again in very general manner, the reinforcing structure comprises a body and a head, the body defining a top wall, and the head defining a bottom wall, the two walls facing each other on passing over the dispenser, substantially at the orifice and at the removable closure member. Once the removable closure member has been folded-back or torn-off, the two walls enable the inside of the dispenser member to be masked, thereby significantly contributing to its appearance by presenting only two closure walls, which walls are clean.

The invention is described more fully below with reference to the accompanying drawings which show an embodiment of the invention by way of non-limiting example.

In the drawings:

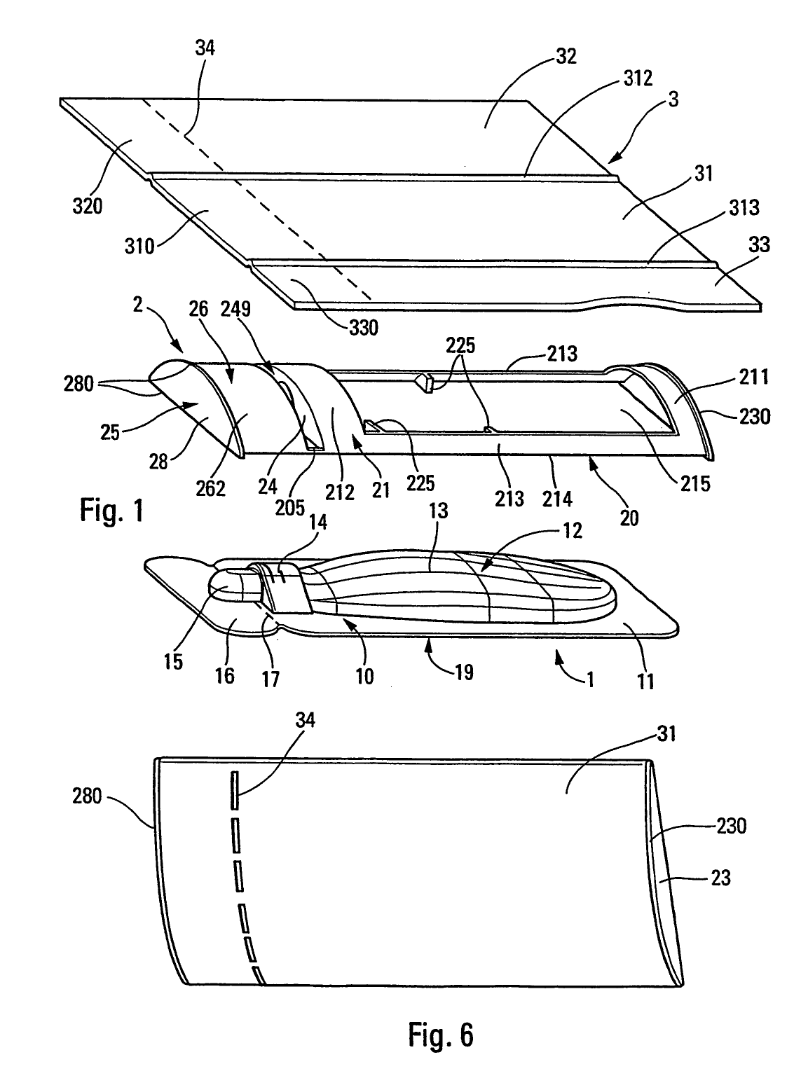

FIG. 1 is an exploded, perspective view from above of a dispenser assembly of the invention;

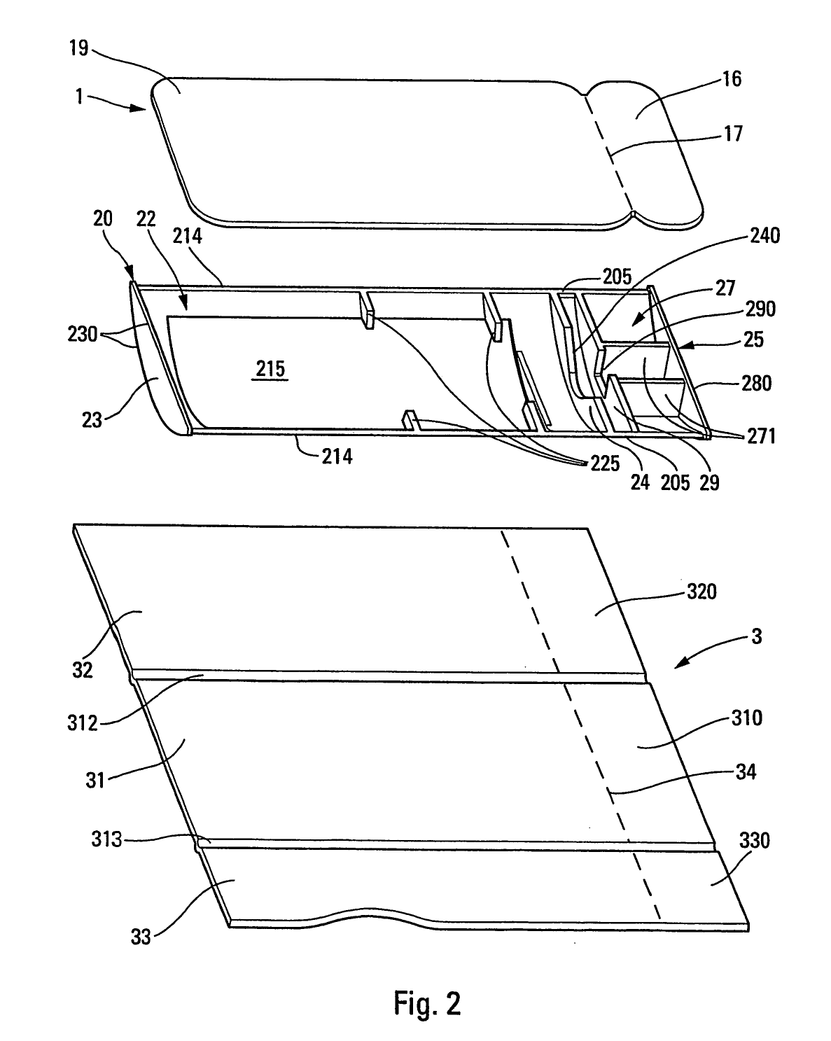

FIG. 2 is another exploded, perspective view of the FIG. 1 dispenser assembly, but seen from below;

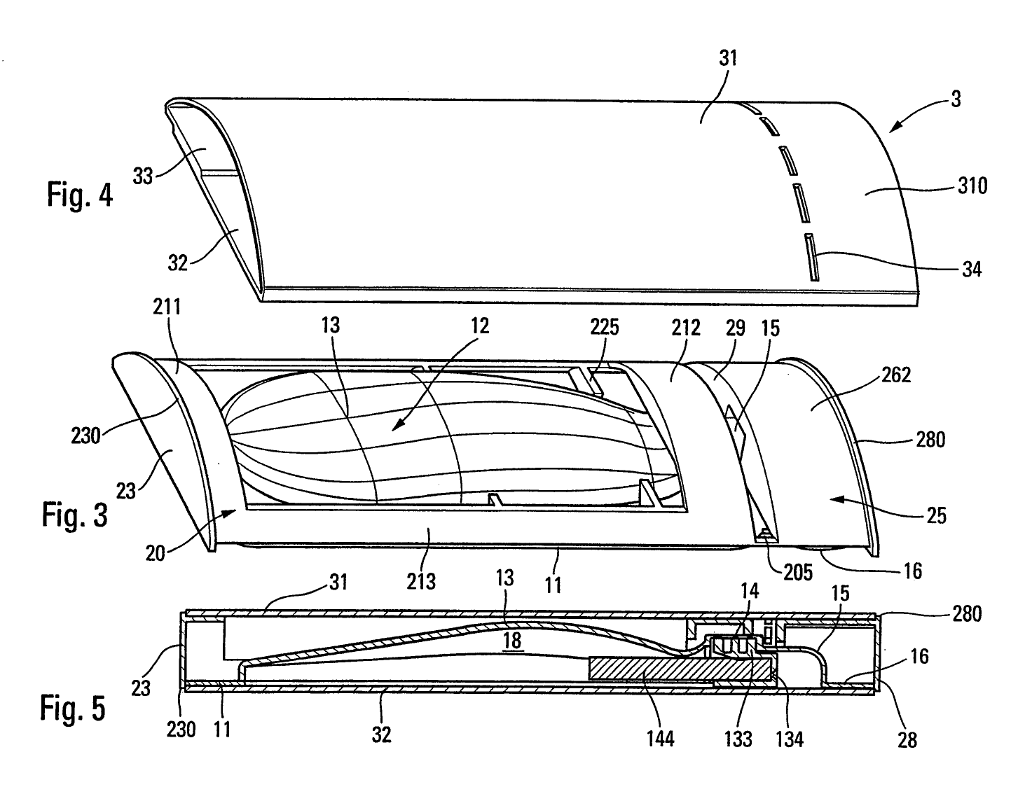

FIG. 3 is a perspective view from above of the dispenser assembly of FIGS. 1 and 2 with the outer wrapper removed;

FIG. 4 is a perspective view of the outer wrapper in its final state, as positioned on the dispenser shown in FIG. 3;

FIG. 5 is a longitudinal and vertical section view through the dispenser assembly of the above-listed figures in its final state; and

FIG. 6 is a perspective view from above of the dispenser assembly of FIG. 5.

The fluid dispenser assembly of the invention comprises three component elements, namely a fluid dispenser 1, a reinforcing structure 2, and an outer wrapper 3. The dispenser 1 is disposed in the reinforcing structure 2, and the assembly constituted in this way is wrapped in the outer wrapper 3.

The fluid dispenser 1 can be similar or identical to the dispenser described in above-mentioned document FR 2 796 368. In this case, it comprises a shaped upper shell 10 associated with a protective sheet or film 19. The shell 10 and the film 19 are connected along their periphery so as to form a flat and plane margin 11. The margin presents thickness that is small, not greater than 1 mm. The sheet 19 is preferably completely flat so that the rear or bottom face of the dispenser is substantially flat. With regard to the shell 10, it forms a projecting portion or dome 12 which inwardly defines a fluid reservoir 18, as can be seen in FIG. 5. The dome 12 is elastically deformable, at least in part, and as a result it constitutes a deformable actuator wall 13 which can be pressed by a finger so as to reduce the inside volume of the reservoir 18, and thus put the fluid under pressure. The dome 12 is connected to a projecting portion 14, which, together with the protective film 19, forms a housing which receives a support or dispenser part 133 which forms a dispenser orifice 134. The support part 133 can advantageously serve as a support to a piece of porous material 144 that is suitable for absorbing the fluid contained in the reservoir 18. The piece of porous material 144 is adjacent to the dispenser orifice 134, such that pressure on the actuator wall 13 causes the fluid contained in the piece of porous material 144 to be expelled through the dispenser orifice 134. By way of example, the projecting portion 14 which is constituted by the shell 10, can be bonded onto the dispenser part 133. Upstream of the dispenser orifice 134, the shell 10 forms another projection 15 which isolates the dispenser orifice 134 from the outside. The projection 15 is situated at a dispenser portion which forms a removable closure member 16 that is separable or foldable along a rupture line 17, as can be seen in FIG. 1. The rupture line 17 passes just in front of the dispenser orifice 134, such that tearing-off or folding the closure member 16 causes the dispenser orifice 134 to be unmasked. The closure member 16 can remain connected to the remainder by being folded-back in this way by pivoting about the rupture line 17, or in a variant, the closure member 16 can literally be removed from the dispenser.

Such a fluid-dispenser is already known from the prior art, and in particular from above-mentioned document FR 2 796 368. The shape in which the dispenser is made must not be considered as limiting, and numerous modifications can be applied to the dispenser without thereby going beyond the ambit of the invention. In particular, the deformable actuator wall can also be in the form of a displaceable actuator wall, and the closure member 16 can be in the form of a simple tab, or can even be omitted. The same applies to the dispenser part 133 which is situated under the projecting portion 14, said dispenser part being easily omitted. The minimum requirement of a fluid dispenser used in the context of the present invention is that the dispenser includes a fluid reservoir provided with a displaceable or deformable actuator wall, such that while the wall is being actuated, fluid is expelled through a dispenser orifice that may optionally be masked by a removable closure member, which may optionally be replaceable. By way of example, it is possible to imagine a fluid dispenser made from two flexible sheets defining the reservoir between them, it being possible to interpose and bond a dispenser piece forming the dispenser orifice between the two sheets.

With regard to the outer wrapper 3, it can be similar or identical to the outer wrapper described in above-mentioned document FR 2 796 368. Here, the outer wrapper 3 shown in the figures is in the form of a case of cylindrical but non-circular section. The wrapper 3 comprises a front face 31, a rear face 32, and a flap 33. The flap 33 is folded onto or under the rear face 32, as can be seen in FIG. 4. The flap 33 and the rear face 32 are fixed together, e.g. by means of adhesive or heat-sealing. The outer wrapper thus forms a kind of case having a front face 31 that is curved or bulging, and a rear face 32, 33 that is substantially flat. This configuration in the form of a case naturally corresponds to the final state of the outer wrapper 3 when it is in place on the reinforcing structure 2. In its initial state, before being mounted on the reinforcing structure 2, the outer wrapper 3 is in the configuration shown in FIGS. 1 and 2, i.e. plane with the front portion 31 situated in central manner, and the portions 32 and 33 disposed on either side of the front portion 31. The front portion 31 of the wrapper 3 is bulging, or more generally curved, since it extends over the shell 10 of the dispenser 1 which forms the dome 12 with its actuator wall 13. The folds 312 and 313 which are formed on the lateral edges of the front portion 31 are designed to be situated at the lateral edges of the dispenser 1 formed by the plane margin 11. In this way, the rear portion 32 and the flap 33 are substantially pressed against the protective film 19, while the bulging front portion 31 covers the shell 10. The outer wrapper 3 is also provided with a cutting or rupture line 34 which extends transversely through the three component portions of the wrapper. The line 34 thus defines a detachable portion formed by the three portions 31, 32, and 33. The detachable portion is thus formed by the segments 310, 320, and 330 of the three portions 31, 32, and 33. Once configured in the form of a case as shown in FIG. 3, the portions 310, 320, and 330 are in the form of a loop connected to the remainder of the case by the rupture or score line 34. In the invention, the score line 34 is aligned with or superposed on the rupture line 17 formed by the dispenser 1, such that removing the separable portion of the wrapper causes the closure member 16 of the dispenser 1 to be folded-back or removed simultaneously.

The outer wrapper 3 is therefore in the form of a case having top and bottom ends that are open. With regard to the front portion 31, it forms a sequence of cylindrical segments having lateral rectilinear edges that are connected to the rear portion, and having curved top and bottom ends that are free and open. In the invention, the outer wrapper 3 is not wrapped directly around the dispenser 1. The dispenser 1 is received in the reinforcing structure 2 which is wrapped in the outer wrapper 3. The reinforcing structure 2 forms both reception means suitable for receiving the fluid dispenser 1, and application surfaces designed to come into contact with the outer wrapper 3. The reinforcing structure 2 comprises a partially closed front face, and a substantially open rear face. The dispenser 1 can thus be inserted into the reinforcing structure 2 via its substantially open rear face. In addition, the reinforcing structure 2 comprises two end plates, namely a trailing end plate 23, and a leading end plate 28. The trailing and leading end plates 23 and 28 close the reinforcing structure 2 at its two ends. It should even be observed that the end plates 23 and 28 form respective projecting rims 230 and 280 which project against the adjacent application zones formed by the structure 2. Between the two end plates having projecting rims 23 and 28, the front face of the structure forms a series of application zones 211, 212, 213, and 262. All the application zones are bulging or curved so as to extend in a curved plane forming a section of cylindrical segment having a radius that is identical to the radius of the front portion 31 of the outer wrapper 3. In this way, the front portion 31 of the wrapper 3 can be applied accurately onto the application zones formed by the front face of the reinforcing structure 2. The application zones of the structure 2 do not form a complete section of cylindrical segment: on the contrary, the zones are interrupted by a wide slot 215 which is bordered by the application zones 211, 212, and 213. A flexible membrane constituted by a thinner wall can be provided at the slot 215. Furthermore, the zones can also be interrupted by a deep groove 249 bordered by respective top and bottom walls 24 and 29. The walls 24 and 29 are connected together by bridges of material 205 which are designed to be folded or broken. In this way, the structure 2 can be folded over on itself or separated into two portions, thus forming a body 20 and a head 25. The body 20 forms the application zones 211, 212, and 213, the slot 215 on its front face 21, the trailing end plate 23 at its bottom end, the top wall 24 at its opposite end, and reception means 225 on its rear face 22. The head 25 forms the application zone 262 on its front face 26, the leading end plate 28 at its top end, the bottom wall 29 at its opposite end, and reception means 290, 271 on its rear face 27. On its rear face, as can be seen in FIG. 2, the structure is substantially open and is bordered at its bottom end by the projecting rim 230 of the trailing end plate 23, laterally by the lateral edges 214 formed on the outside edges of the lateral application zones 213, and at its top end by the projecting rim 280 of the leading end plate 28. It should also be observed that each of the top and bottom walls 24 and 29 has a respective notch 240 and 290 formed therein. In addition, ribs 225 and 271 are also provided which, together with the bottom edges of the walls 24 and 29, form the reception means enabling the dispenser 1 to be positioned and held in place in the reinforcing structure 2. The dispenser 1 is positioned in such a manner that its actuator wall 13 is situated at the slot 215, and its projecting portion 14 bears against the notch 240 of the wall 24. In addition, the projection 15 comes to bear against the notch 290 of the wall 29. The plane margin 11 comes to bear against the ribs 225 and 271 and against the bottom end edges of the walls 24 and 29. The dispenser 1 is disposed in the structure 2 so that its rupture line 17 is situated between the two walls 24 and 29 which are connected together by bridges of foldable or breakable material 205. In this way, the removable closure member 16 of the dispenser 1 is fully received inside the head 25 of the structure 2, while the body 20 receives the remainder of the dispenser 1. The lateral edges of the plane margin 11 can rest on the edges 214 of the structure 2, but the top and bottom edges of the plane margin 11 are placed inside the structure 2, bearing against the trailing and leading end plates 23 and 28, as can be seen very clearly in FIG. 5. In this way, the dispenser 1 is completely wedged between the two end plates 23 and 28. In addition, the dispenser 1 is wedged laterally by means of the portions 14 and 15 being engaged in the notches 240 and 290 of the walls 24 and 29, and by means of its dome 12 being disposed between the ribs 225. This can be seen in FIG. 3. It should easily be understood from this figure that it is possible to press on the actuator wall 13 through the slot 215, and that it is possible to fold or remove the closure member 16 by tearing-off or by folding-back the head 25 by bending or rupturing the bridges of material 205. The closure member 16 is entrained by the head 25 as a result of it bearing on the ribs 271 with its projection 15 being inserted in the groove 290.

Once the dispenser 1 is inserted in this way in the reinforcing structure 2, it suffices to wrap it by means of the outer wrapper 3 that is closed thereabout. The initially plane front portion 31 takes up the shape of the application zones 211, 212, 213, and 262 of the front face of the reinforcing structure 2 so as to adopt the shape of a cylindrical segment. This is also the case at the slot 215, given that it is completely bordered by the application zones. The front portion 31 of the wrapper 3 adopts this configuration in uniform manner, without being able to tell where it is in contact with the application zones of the structure 2. However, as a result of the application zones of the structure 2 extending over the entire periphery of the bulging front portion 1, it is not possible to deform the margin of the front portion 31 which is completely supported by the structure 2. It is only at the slot 15 that the bulging front portion 31 can be pressed in to actuate the wall 13 of the dispenser 1. Once the front portion is shaped in this way on the application zones of the structure 2, it suffices to fold the rear portion 32 and the flap 33 until they are in contact with the protective sheet 19 of the dispenser 1. It then suffices to fix the rear portion 32 and the flap 33 together, e.g. by means of adhesive or heat-sealing. It should be observed that the dispenser 1 is not secured inside the structure 2 until it is wrapped in the outer wrapper 3. It is not necessary to secure the dispenser 1 inside the structure 2, since it is finally secured by putting the outer wrapper 3 into place, thereby permanently blocking the dispenser 1 inside the structure 2. In addition, as can be seen in FIG. 5, the outer wrapper 3 is prevented from sliding over the structure 2 as a result of the top and bottom ends of the wrapper 3 coming into abutment against the projecting rims 230 and 280 formed by the trailing and leading end plates 23 and 28. In this way, the wrapper 3 is completely blocked in position on the structure 2. In addition to their blocking function, the end plates 23 and 28 enable the bottom and the top portion of the dispenser assembly to be closed in attractive manner. The same applies for the top and bottom walls 24 and 29 which enable the body 20 and the head 25 to be closed, particularly when the head 25 has been folded-back or removed from the body 20, thereby uncovering the dispenser orifice 134 of the dispenser 1. In other words, the end plates 23 and 28, and the walls 24 and 29, enable the internal elements of the dispenser assembly as formed by the dispenser 1 to be hidden. Thus, the appearance of the dispenser is significantly improved compared to the dispenser in document FR 2 796 368. In its initial state before use, the dispenser assembly is in the form shown in FIG. 6. The user sees only the outer wrapper 3, and the trailing and leading end plates 23 and 28. The dispenser 1 is thus completely masked or invisible. Even when the dispenser orifice is unmasked by folding-back or removing the head 25 and the closure member 16 along the score line 34 overlying the groove 249 having the rupture line 17 of the dispenser 1 extending along its bottom, the top and bottom walls 24 and 29 still continue to mask the dispenser 1, which is visible only at its dispenser orifice 134.

By using the reinforcing structure 2, the appearance of the dispenser assembly is significantly improved, it is easier to hold, and it can be opened more cleanly and more easily. Forming the structure 2 in the form of a body and a head separated by a deep groove 249, enables the rupture or fold line to be located very clearly, thereby making the dispenser assembly much easier to open.

1. A fluid dispenser assembly comprising:
a dispenser (1) comprising a fluid reservoir (18) defining a deformable actuator wall (13), a dispenser orifice (134) through which the fluid is dispensed by pressing on the deformable actuator wall, and a removable closure member (16) which covers the dispenser orifice at least before it is first used; and
an outer wrapper (3) which surrounds the dispenser,
the dispenser being characterized in that it further comprises a substantially rigid reinforcing structure (2) provided with reception means (225, 240, 290, 271) for receiving the dispenser (1), and defining application zones (211, 212, 213, 262) where the outer wrapper is in contact with the reinforcing structure in such a manner as to surround, at least in part, both the dispenser and the reinforcing structure.

2. A dispenser assembly according to claim 1, in which the reinforcing structure (2) includes a slot (215), the actuator wall (13) of the dispenser being positioned at the slot, the outer wrapper (3) covering the slot (215) so that the actuator wall (13) can be actuated through the wrapper.

3. A dispenser assembly according to claim 2, in which the slot (215) is bordered by first application zones (211, 212, 213) for the outer wrapper.

4. A dispenser assembly according to claim 2, in which the reinforcing structure (2) includes a body (20) defining a front face (21) and a rear face (22), the front face forming the slot (215) and the first application zones (211, 212, 213), and the rear face (22) being substantially open and provided with first reception means (225, 240) for receiving the dispenser, such that the dispenser is engageable in the body via its rear face, and is positioned in said body with its actuator wall (13) accessible through the slot (215) of the body (20).

5. A dispenser assembly according to claim 4, in which the body (20) includes a trailing end plate (23).

6. A dispenser assembly according to claim 4, in which the first application zones (211, 212, 213) of the body (20) comprise a bottom zone (211), a top zone (212), and two lateral zones (213) connecting the bottom zone to the top zone, said zones bordering the slot (215).

7. A dispenser assembly according to claim 6, in which the first application zones are curved in such a manner as to form together a cylindrical segment in which the slot (215) is pierced.

8. A dispenser assembly according to of claim 4, in which the body (20) includes a top wall (24) at which the dispenser orifice (134) opens out.

9. A dispenser assembly according to any one of claim 4, in which the dispenser (1) includes a substantially plane rear face (19) which closes the open rear face (22) of the body, the outer wrapper (3) covering the rear face (19) of the dispenser.

10. A dispenser assembly according to claim 1, in which the reinforcing structure (2) includes a head (25) defining a front face (26) and a rear face (27), the front face (26) forming a second application zone (262) for the outer wrapper, and the rear face (27) being open and provided with second reception means (271, 290) for receiving the removable closure member (16) of the dispenser.

11. A dispenser assembly according to claim 4, in which the head (25) is connected to the body (20) by at least one bridge of foldable or breakable material (205), so that the head can be folded onto or detached from the body, taking with it the removable closure member (16), thereby uncovering the dispenser orifice (134).

12. A dispenser member according to claim 10, in which the head (25) includes a bottom wall (29) through which the removable closure member (16) passes.

13. A dispenser member according to any one of claim 10, in which the head (25) includes a leading end plate (28) which covers and closes the head.

14. A dispenser assembly according to claim 10, in which the second application zone (262) is curved in such a manner as to form a cylindrical segment.

15. A dispenser assembly according to claim 7, in which the first application zones (211, 212, 213) and the second application zone (262) present identical curvature.

16. A dispenser assembly according to claim 5, in which each of the trailing and leading end plates (23, 28) forms a respective rim (230, 280) which projects against the application zones (211, 212, 213, 262).

17. A dispenser assembly according to claim 1, in which the application zones (211, 212, 213, 262) are curved in such a manner as to form a cylindrical segment on which the outer wrapper (3) is applied.

18. A dispenser assembly according to claim 1, in which the reinforcing structure (2) includes a trailing end plate (23) and a leading end plate (28) between which the outer wrapper is held.

19. A dispenser assembly according to claim 1, in which the reinforcing structure (2) comprises a body and a head, the body defining a top wall (24), and the head defining a bottom wall (29), the two walls (24, 29) facing each other and passing over the dispenser, substantially at the orifice (134) and at the removable closure member (16).
